(19) United States
(12) Patent Application Publication
(10) Pub. No.: US 2002/0138627 A1
(43) Pub. Date: Sep. 26, 2002

(54) Apparatus and method for managing persistent network connections

(76) Inventors: Michael T. Frantzen, West Chicago, IL (US); David E. Ballman, Fremont, CA (US); William R. Danielson, Mountain View, CA (US)

Correspondence Address: SUN MICROSYSTEMS INC, 901 SAN ANTONIO RD, MS PALO1-521, PALO ALTO, CA, 94303, US

(21) Appl. No.: 09/817,630

(22) Filed: Mar. 26, 2001

(51) Int. Cl. G06F 15/173

(52) U.S. Cl. 709/227

(57) ABSTRACT

Described is a firewall that automatically identifies active persistent network connections and keeps these connections alive. When the firewall determines that a particular network connection has been idle for a predetermined period of time, the firewall does not automatically delete the connection's state from its database. Instead, the firewall tries to determine whether the connection is an active persistent connection which should be kept alive for a longer period of time. To this end, the firewall sends out a message or a probe before deleting the state information entry of an idle connection from its database. The probe is designed to elicit responses from the participants of the network connection that would provide information on the current condition of the network connection. The firewall then senses the network activity caused by these responses and determines if the connection in question is still active and should be kept alive.

### FIELD

The present invention generally relates to techniques for establishing and maintaining network connections. The present invention also relates to techniques for providing network security.

### BACKGROUND

A company's assets are at risk when it connects to the Internet. Unrestricted access and sharing of data and other resources may create serious security problems. For example, it is highly desirable to protect certain sensitive data from outside intruders, while making these data freely available to company employees accessing it from within the company's own network. In the recent years, a number of techniques have been developed to protect corporate private network against unauthorized use and to generally control access thereto. One of the most common techniques for securing a private network is the use of a firewall. A firewall is a highly secure host that acts as a barrier between internal network, such as a private corporate network, and all outside networks, such as the Internet. A firewall has two functions. Firstly, it acts as a gateway which passes data between the networks. Secondly, it acts as a barrier that blocks free passage of data to and from the private network. More specifically, the firewall computer is configured such that it allows network connections that are permitted by the company's security policy and refuses all the others.

The most commonly utilized type of firewall architecture is a packet-filtering firewall. It is well known in the art that most modern network communication devices communicate using data packets. For example, a TCP/IP packet contains, among other data, information on the network address and the connection port of the sender, information on the network address and the connection port of the recipient, and information on the type of the communication protocol used. The firewall uses the aforementioned information to filter out the packets of the network connections that are in violation of the security policy. For example, the firewall may be configured to filter out all data packets sent from outside the private network, except for the packets originating in specific hosts presumed to be secure and specified by the security policy of the network.

One specific type of packet filtering firewall architecture is a stateful firewall. Once any specific network connection is established across the firewall, the stateful firewall stores the state of each such network connection in its database. The network connection state entry includes, among other data, the network address and port information of the sender, the network address and port information of the recipient and the time of the last packet transfer. Each data packet corresponding to any specific network connection is handled by the stateful firewall in accordance with a state of this connection stored in the firewall's database. One example of a stateful firewall is Sun Screen firewall developed by Sun Microsystems of Palo Alto, Calif.

If a particular connection is not active for an extended period of time, a stateful firewall will assume that the connection has expired and then it will delete the connection by removing the connection state information entry from its database. This is done to prevent unrecoverable memory consumption. This aspect of operation of the stateful firewall is illustrated in FIG. 1. Specifically, the firewall checks at 10 whether the connection is idle. This is done, for example, by computing the time interval since the last packet transfer corresponding to this connection. If the connection is idle, the firewall simply deletes the connection state entry from the database at 11, which destroys the connection. The operation of the algorithm terminates at 12. If the firewall determines that the connection is not idle, is does not delete the connection state from its database.

On the other hand, it is desirable for some applications, such as telnet to allow very long periods of user's inactivity. Telnet is an application that communicates with a remote host using a TELNET protocol, enabling a user to execute shell commands on the remote host and displaying the output of these commands. Both the telnet command and the TELNET protocol are well known in the art. For example, a user may want to telnet into a host, perform some actions on that host, and leave the telnet idle for several days.

Then the user may want to continue using the same connection several days later. It would be convenient if the user would not have to re-authenticate himself. But in the above example, the conventional stateful firewall will have likely deleted the connection after a few hours of user's inactivity. Thus, the user returning to work days later will discover that his telnet connection has hung. Thus, the user will have use the telnet to establish a new connection to the remote host and authenticate himself again by entering his name and a secret password. This lengthy process would be unnecessary if the firewall would recognize persistent connections and keep them “alive” for extended periods of time.

### SUMMARY

To overcome the limitations described above, and to overcome other limitations that will become apparent upon reading and understanding the present specification, apparatus, methods and articles of manufacture are disclosed that keep persistent connections alive in a network configuration involving a stateful firewall.

One aspect of the invention is a method for managing a network connection in a network configuration comprising a firewall.

Another aspect of the invention is a computer readable medium containing a program for managing network connections is a network architecture including a firewall.

Yet another aspect of the invention is a firewall configured to manage network connections.

According to the invention, the firewall automatically determines whether the network connection is active; and deletes a state of the network connection if the network connection is not active.

The firewall may determine the condition of the network connection by generating a probe, which causes a network activity corresponding to the network connection in question. The firewall subsequently senses this network activity to determine whether the network connection is active.

The firewall may include a database for storing information relating a state of the network connection and update this information in response to the network activity sensed by the firewall. The information stored in the database may include an idle time counter of the network connection. If the firewall determines that the network connection is active, it would reset this counter.

The aforementioned network connection can be between a client and a server. In this case the probe may include a packet containing data from the server, the receipt of which has been already acknowledged by the client. The network activity may include a response from the client indicating a condition of the network connection. Specifically, the response of the client may include a data receipt acknowledgment if the network connection is active and an error message if the network connection is not active. The probe can be nondestructive with respect to the network connection and it can be generated by the firewall. Alternative implementations of the probe are possible.

### DESCRIPTION OF THE DRAWINGS

Various embodiments of the present invention will now be described in detail by way of example only, and not by way of limitation, with reference to the attached drawings wherein identical or similar elements are designated with like numerals.

FIG. 1 illustrates operation of a conventional firewall;

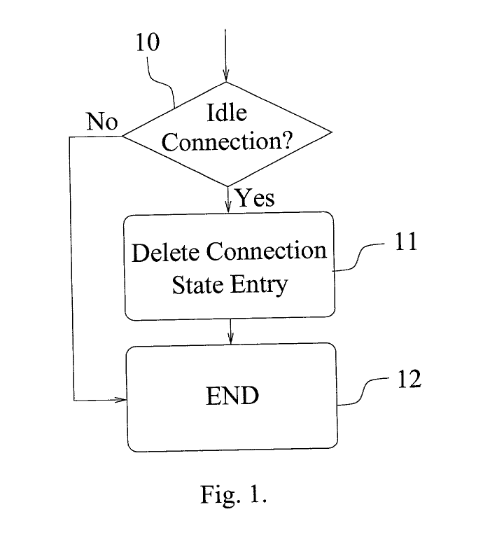

FIG. 2 illustrates a typical network architecture utilizing a firewall;

FIG. 3 illustrates operation of one embodiment of the inventive firewall.

### DETAILED DESCRIPTION

To overcome the above limitations and disadvantages attributable to the conventional firewall architecture, the inventive firewall automatically identifies active persistent network connections and keeps these connections alive.

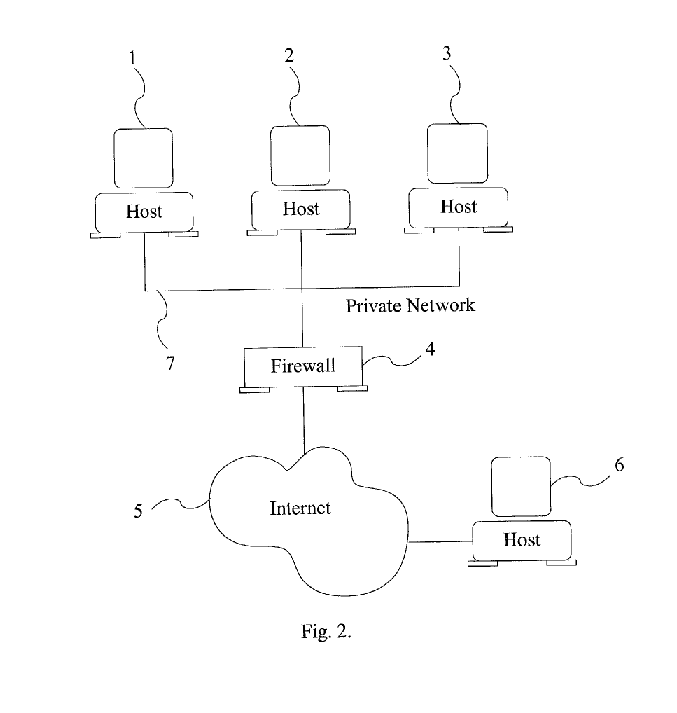

A typical secure network configuration using a firewall is illustrated in FIG. 2. Secure private network 7 links hosts 1, 2, and 3 together. This network is connected to the external global network 5, such as Internet, using a secure firewall computer 4. This computer enforces security policy of the private network by filtering out network packets of connections that are in violation of this security policy. On the other hand, the connections complying with the security policy are being permitted by the firewall 4. For example, traveling employee may telnet into computer 2, located on the private network 7 from a remote host 6, connected to the Internet 5, assuming that the security policy of the private network 7 allows such a connection. This connection may become idle after a period of time.

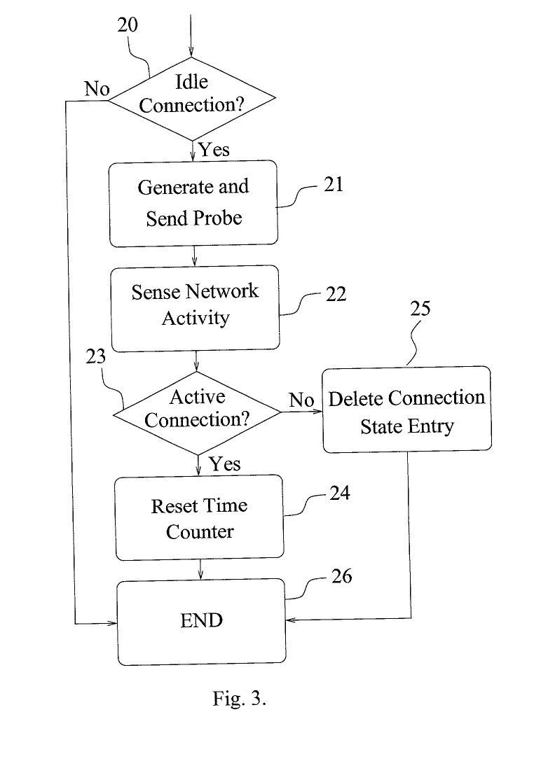

According to an embodiment of the inventive method illustrated in FIG. 3, when the firewall 4 determines at 20 that a particular network connection has been idle for a predetermined period of time, the inventive firewall 4 does not automatically delete the connection's state from its database. Instead, the inventive firewall 4 tries to find out if the connection is an active persistent connection which should be kept alive for a longer period of time. To this end, the inventive stateful firewall sends out a message or a probe at 21 before deleting the state information entry of an idle connection from its database. The inventive probe is designed to elicit responses from the participants of the network connection that would provide information on the current condition of the network connection. The firewall then senses the network activity caused by these responses at 22 and determines if the connection in question is still active and should be kept alive, see FIG. 3 at 23. If the network connection is determined to be active, the corresponding idle time counter in the firewall database is reset at 24. Otherwise, the connection state entry is deleted from the database at 25. The operation of the algorithm terminates at 26. If the connection is determined by the firewall not to be idle, the firewall does not alter its state in the database.

In one embodiment of the invention, the aforementioned probe sent by the firewall is designed to be nondestructive to the network connection. The probe elicits a network activity either by the server or by the client participating in the connection. The term “network activity” will be used herein to refer to generating a network message or packet or exchanging messages or packets in accordance with a network protocol. If the firewall then determines that this activity characterizes an active network connection, it would reset the idle time counter used by the firewall to identify the idle connections. This, in turn, would prevent the firewall from deleting the state of the corresponding persistent network connection.

The specific probe used in one embodiment of the invention is known as a BSD4.3 keepalive probe. This probe applies to TCP/IP connections. Specifically, the probe comprises a fake TCP/IP data packet sending the client data from the server. The data sent to the client is the data that the client has already acknowledged receiving. The following is an exemplary embodiment of such a probe.

Server sends: “Here is the data at position 100”

Client sends: “I got the data at position 100”

—idle—

Probe: “Here is the data at position 99”

Client sends: “I already acknowledged getting the data up to position 100”.

As will be appreciated by those of skill in the art, the exemplary probe is arranged such that it comprises a copy of a message and/or data that have already been sent to the client by the server during preceding client-server communication. Accordingly, the client has already acknowledged receiving these data and, therefore, the client responds with the message “I already acknowledged getting the data up to position 100.”

The firewall passes the client's reply to the server who ignores the probe packet and the client's response. The firewall monitors the above client-server communication and determines that the network connection is still active. Accordingly, the firewall resets its idle time counter and keeps the connection alive.

In the event the client has deleted the connection, upon the receipt of the probe packet the client will respond with the error message indicating that the collection is not active, followed by a RESET instruction. The firewall will sense this information and delete the corresponding connection state entry.

In the event the server has deleted the connection, the server will respond with the message indicating that it never sent data at position 100 followed by a RESET. This will cause the firewall and the client to destroy the connection.

Finally, it will be appreciated by those of skill in the art that if the client host is down, no responses are ever elicited and the inventive firewall will expire the connection as the conventional one.

While the invention has been described herein with reference to preferred embodiments thereof, it will be readily apparent to persons of skill in the art that various modifications in form of detail can be made with respect thereto without departing from the spirit and scope of the invention as defined in and by the appended claims. For example, the present invention is not limited to TCP/IP connections. The inventive concept of identifying active persistent network connections before deleting them can apply to other network architectures based on a wide variety of network communication protocols. The specific format and content of the probe sent by the firewall is also not critical to the invention. The probe can be implemented in a variety of formats and need only to elicit responses from the participants of the network connection. Finally, it is not essential that the probe be sent by the firewall. Any other participant of the network connection or any additional network entity can generate and send the probe.

Those of skill in the art will undoubtedly appreciate that the invention can be implemented on a vide variety of computer systems including, but not limited to, general purpose computers and special purpose computers such as network appliances. As well known in the art, a computer consists at least of a central processing unit, a memory unit, and an input/output interface. The aforementioned computer components can be arranged separately, or they can be combined together into a single unit. The computer memory unit may include a random access memory (RAM) and/or read only memory (ROM). The present invention can be implemented as a computer program embodied in any tangible storage medium, or loaded into the computer memory by any known means. As an alternative to implementing the present invention as a computer program, the present invention can be also embodied into an electronic circuit. This embodiment may provide an improved performance characteristics.

1. A method for managing a network connection in a network configuration comprising a firewall, said method comprising:
a. automatically determining whether said network connection is active; and
b. deleting a state of said network connection if said network connection is not active.

2. The method of claim 1, wherein said automatically determining whether said network connection is active comprises:
a1. generating a probe, said probe causing a network activity corresponding to said network connection; and
a2. sensing said network activity to determine whether said network connection is active.

3. The method of claim 2, wherein said firewall comprises a database for storing information relating a state of said network connection and wherein, in response to said network activity, said firewall updates information stored in said database.

4. The method of claim 3, wherein said stored information comprises an idle time counter of said network connection and wherein said firewall resets said time counter if said network connection is determined to be active.

5. The method of claim 2, wherein said network connection is between a client and a server and said probe comprises a packet containing probe data, and wherein said probe data is a copy of first data, said first data having been sent by the server and received and acknowledged by said client during preceding communication between said client and said server.

6. The method of claim 5, wherein said network activity comprises a response from said client indicating a condition of said network connection.

7. The method of claim 6, wherein said response of said client comprises a data receipt acknowledgment if said network connection is active and an error message if said network connection is not active.

8. The method of claim 2, wherein said probe is nondestructive with respect to said network connection.

9. The method of claim 2, wherein said probe is generated by said firewall.

10. A computer readable medium embodying a program for managing a network connection in a network configuration comprising a firewall, said program comprising:
a. automatically determining whether said network connection is active; and
b. deleting a state of said network connection if said network connection is not active.

11. The computer readable medium of claim 10, wherein said automatically determining whether said network connection is active comprises:
a1. generating a probe, said probe causing a network activity corresponding to said network connection; and
a2. sensing said network activity to determine whether said network connection is active.

12. The computer readable medium of claim 11, wherein said firewall comprises a database for storing information relating a state of said network connection and wherein, in response to said network activity, said firewall updates information stored in said database.

13. The computer readable medium of claim 12, wherein said stored information comprises an idle time counter of said network connection and wherein said firewall resets said time counter if said network connection is determined to be active.

14. The computer readable medium of claim 11, wherein said network connection is between a client and a server and said probe comprises a packet containing probe data, and wherein said probe data is a copy of first data, said first data having been sent by the server and received and acknowledged by said client during preceding communication between said client and said server.

15. The computer readable medium of claim 14, wherein said network activity comprises a response from said client indicating a condition of said network connection.

16. The computer readable medium of claim 15, wherein said response of said client comprises a data receipt acknowledgment if said network connection is active and an error message if said network connection is not active.

17. The computer readable medium of claim 11, wherein said probe is nondestructive with respect to said network connection.

18. The computer readable medium of claim 11, wherein said probe is generated by said firewall.

19. A firewall configured for managing a network connection, wherein said firewall automatically determines whether said network connection is active and deletes a state of said network connection if said network connection is not active.

20. The firewall of claim 19, wherein said firewall generates a probe, said probe causing a network activity corresponding to said network connection; and senses said network activity to determine whether said network connection is active.

21. The firewall of claim 20, wherein said firewall comprises a database for storing information relating a state of said network connection and wherein, in response to said network activity, said firewall updates information stored in said database.

22. The firewall of claim 21, wherein said stored information comprises an idle time counter of said network connection and wherein said firewall resets said time counter if said network connection is determined to be active.

23. The firewall of claim 20, wherein said network connection is between a client and a server and said probe comprises a packet containing probe data, and wherein said probe data is a copy of first data, said first data having been sent by the server and received and acknowledged by said client during preceding communication between said client and said server.

24. The firewall of claim 23, wherein said network activity comprises a response from said client indicating a condition of said network connection.

25. The firewall of claim 24, wherein said response of said client comprises a data receipt acknowledgment if said network connection is active and an error message if said network connection is not active.

26. The firewall of claim 20, wherein said probe is nondestructive with respect to said network connection.

27. The firewall of claim 20, wherein said probe is generated by said firewall.

28. A computer system comprising at least a central processing unit and a memory, said memory storing a program for managing a network connection in a network configuration comprising a firewall, said program comprising:
a. automatically determining whether said network connection is active; and
b. deleting a state of said network connection if said network connection is not active.

29. The computer system of claim 28, wherein said automatically determining whether said network connection is active comprises:
a1. generating a probe, said probe causing a network activity corresponding to said network connection; and
a2. sensing said network activity to determine whether said network connection is active.

30. The computer system of claim 29, wherein said firewall comprises a database for storing information relating a state of said network connection and wherein, in response to said network activity, said firewall updates information stored in said database.

31. The computer system of claim 30, wherein said stored information comprises an idle time counter of said network connection and wherein said firewall resets said time counter if said network connection is determined to be active.

32. The computer system of claim 29, wherein said network connection is between a client and a server and said probe comprises a packet containing probe data, and wherein said probe data is a copy of first data, said first data having been sent by the server and received and acknowledged by said client during preceding communication between said client and said server.

33. The computer system of claim 32, wherein said network activity comprises a response from said client indicating a condition of said network connection.

34. The computer system of claim 33, wherein said response of said client comprises a data receipt acknowledgment if said network connection is active and an error message if said network connection is not active.

35. The computer system of claim 29, wherein said probe is nondestructive with respect to said network connection.

36. The computer system of claim 29, wherein said probe is generated by said firewall.
